(19) United States
(12) Patent Application Publication
(10) Pub. No.: US 2010/0037522 A1
(43) Pub. Date: Feb. 18, 2010

(54) THERMALLY INSULATING DOOR

(76) Inventors: Martin Wirth, Tettnang (DE); Klaus Wirth, Tettnang (DE)

Correspondence Address: BURR & BROWN, PO BOX 7068, SYRACUSE, NY, 13261-7068, US

(21) Appl. No.: 12/581,970

(22) Filed: Oct. 20, 2009

Related U.S. Application Data
(63) Continuation of application No. PCT/DE2008/000641, filed on Apr. 18, 2008.

(30) Foreign Application Priority Data
Apr. 20, 2007 (DE) 10 2007 019 182.2
Apr. 26, 2007 (DE) 10 2007 020 173.9
Jun. 19, 2007 (DE) 10 2007 028 596.7

(51) Int. Cl. E05F 15/20; E05D 15/00; E05D 15/06

(52) U.S. Cl. 49/31; 49/226; 160/330

(57) ABSTRACT

The invention proposes a sliding door for cold stores, in particular deep-freeze stores, which ensures good sealing around the frame, the intention being to avoid damage when a vehicle drives through too quickly when the door is not in a fully open state. This is achieved according to the invention in that at least one door leaf of the cold-store sliding door has at least one rigid region and at least one flexible region.

### CROSS REFERENCE TO RELATED APPLICATIONS

This application is a continuation of International Application No. PCT/DE2008/000641, filed Apr. 18, 2008, which designated the United States, and claims the benefit under 35 USC §119(a)-(d) of German Application Nos. 10 2007 019 182.2 filed Apr. 20, 2007, 10 2007 020 173.9 filed Apr. 26, 2007 and 10 2007 028 596.7 filed Jun. 19, 2007, the entireties of which are incorporated herein by reference.

### FIELD OF THE INVENTION

The invention relates to a thermally insulating door.

### BACKGROUND OF THE INVENTION

Areas which require thermal insulation, e.g. cold stores, always give rise to the problem that openings should last only for a brief period of time, in order for the temperature in the interior of the cold store to be maintained at an energy-efficient level. In cold stores which can admit vehicles, use is made, for this purpose, of sliding doors which are opened, and closed again, at high speed. The door leaves here are of cold-insulating design, in order to reduce the loss of cold in the cold store.

Various designs of such sliding doors are in use. A first example uses rigid door leaves made up of a sandwich element, i.e. cover shells made of sheet metal or the like on both sides and filled with polyurethane insulating material in the core. The sealing around the frame takes place via rubber sealing elements which are heated via the frame in order to prevent the same from freezing solid when exposed to deep freezing.

The advantage of the rigid door leaves is the sealed attachment to the door frame with the associated frame heating. The disadvantage, however, is that, when vehicles e.g. stacker trucks, drive through too quickly, the door leaf is frequently permanently damaged.

In order to avoid this disadvantage, a second prior art design makes use of flexible door leaves. However, these flexible door leaves, as a result of the loose attachment to the frame, require extremely pronounced frame heating and ventilation in order to prevent freezing.

### SUMMARY OF THE INVENTION

It is an object of the invention to provide a thermally insulating door for areas which are to be insulated, in particular deep-freeze stores, which, in the first instance, allows good attachment around the frame, with the associated advantages, and, at the same time, avoids, or at least reduces, the above-mentioned damage when a vehicle drives through quickly.

This object is achieved by a door according to the present invention, which is distinguished by a door leaf that has at least one rigid region and at least one flexible region.

This makes it possible to avoid the disadvantages of the two prior art designs mentioned above.

Good frame attachment to the door leaf is possible by way of the rigid region of the door leaf, while the flexible region reduces or avoids damage when vehicles, for example stacker trucks or the like, drive through too quickly.

In a preferred embodiment of the invention, the door is designed as a single- or multi-leaf sliding door, and in the case of a double-leaf construction the door leaves close centrally and are pushed apart from one another on both sides during opening. This allows a sufficiently large door opening to open, and close, at high speed.

The abovementioned advantages are also achieved if the door leaves designed according to the invention are used in swing doors.

The bearing means for bearing the door leaf or the door leaves are preferably fitted on the rigid region, in order to improve the attachment to the door frame.

In another embodiment, in particular an embodiment as a sliding door, for this purpose the rigid region of the door leaf is designed such that it extends, at least on the top side, over the entire width of the door leaf. In this way, the bearing means can act over the entire width of the door leaf in the rigid region.

Furthermore, the flexible region is advantageously arranged, at least in part, on the drive-through side of the door leaf, this side, in the open state, being oriented toward the envisaged drive-through opening. The abovementioned risk of damage arises predominantly in this region of the door when a vehicle drives through too quickly, in which case the advantages of a flexible configuration are utilized to a particularly good effect if this region of the door leaf is configured in a flexible manner.

It is further preferred for the width of the flexible region to be designed to increase in the direction of the floor. This configuration takes account of the fact that the greatest risk of damage when vehicles, at least fork lift stackers, drive through is in the floor region, since the height of a pallet carried in front of a stacker truck does not usually take up the entire height of the door. The risk of collision thus exists, in particular, in the region in the vicinity of the floor. When the body of a vehicle reaches the sliding door, the latter is usually already open to the extent where the entire vehicle can pass through without any difficulty.

In a further embodiment of the invention, the flexible region can extend over the entire width of the door leaf. In this embodiment too, the flexible region is preferably arranged beneath the rigid region. A wide variety of different contours are conceivable here for the two regions. Possible options are oblique or curved transitions from the rigid region into the flexible region, as is a rectilinear, horizontal transition, in which, for example, the two regions may have the contour of a rectangle.

Furthermore, a covering is advantageously provided on the drive-through side of the flexible region. This covering protects the flexible material in the event of collisions and also allows functional elements, for example heating elements or the like, to be fitted.

Such a covering is preferably designed as a rigid profile, for example as a U-shaped profile, which not only covers the flexible material of the door leaf on the end side, but also engages around its periphery, on both sides in the case of a U-shaped profile.

As has already been mentioned, for use in a cold store, a heater is preferably provided around at least part of the periphery of the door leaf, in order to avoid freezing of the door. This heating around the periphery is accommodated in the flexible region of the door leaf, preferably in the covering around the periphery.

Furthermore, a seal is advantageously provided around at least part of the periphery of the door leaf. This seal ensures good thermal insulation when the door is closed.

It is preferable to provide, in addition, a safety element which can be used for safeguarding individuals. If such an individual (or an object) is located in the door opening as the door is closing, then such a hazard situation is sensed by the safety element and communicated to the door-control means. The closing movement can then be interrupted and the door can be opened again. Injury as a result of getting caught or pinched in the door, or destruction of an object as a result of the latter becoming caught in the door, is thus prevented. Overloading of the door drive by blocking caused by an individual or an object is also prevented.

The safety element may be of deformable configuration and provided with a sensor which detects such a deformation. In combination with a deformable safety element, or without a deformable safety element, it is possible to use all sensors which are suitable for sensing a hazard situation. In addition to mechanical switches, possible examples here are inductive, capacitive, electromagnetic and/or ultrasonic sensors.

The safety element, in particular in the case of a deformable element, is designed as a strip which is fitted on the inner narrow side, that is to say the drive-through side of the door leaf, in particular of the flexible region. Fastening can advantageously be carried out here, as indicated above, on a flexible-region covering provided on the drive-through side.

The safety element, in addition, can overlap the seal in order to protect the seal against damage. Furthermore, such a safety element in the manner of a labyrinth seal additionally enhances the insulating effect of the seal.

The rigid region of the door leaf is preferably configured such that it extends down to the floor. This is preferably the case on the outer side of the door leaf, where the abovementioned risk of damage when a vehicle drives through too quickly does not arise. The fact that the rigid region extends down to the floor also provides the advantage of ensuring good frame attachment on the outer side of the door leaf.

Furthermore, in this case, the rigid region may additionally comprise a floor-guide element, as a result of which it is possible to realize reliable wall-parallel guidance of the door leaf as it slides.

The rigid region of the door leaf may be configured like prior-art rigid cold-store sliding doors, e.g. as a sandwich element with cover shells on both sides of a core made of insulating material, for example polyurethane insulating material.

The flexible region is advantageously likewise formed with an insulating material, e.g. in the form of flexible insulating mats. Use is advantageously made of a closed-cell insulating material which, on the one hand, provides good cold insulation, but, on the other hand, is also less sensitive to moisture and dirt than open-cell insulating material.

Flexible reinforcing elements are advantageously provided in order to stabilize the flexible door-leaf region mechanically. Such reinforcing elements may be incorporated as inserts in the flexible insulating materials, flexible rods, strips or the like being possible examples here. It is particularly advantageous in this context to use spring steel, which is extremely robust and dimensionally stable and thus even in the flexible region of the door leaf can ensure planar alignment of the door leaf when the latter is in the rest state, without having any force applied to it.

At least the flexible region of the door leaf can be provided with a flexible surface covering. This ensures, on the one hand, additional protection of the flexible region against dirt and moisture and, on the other hand, also an improved appearance. Furthermore, this flexible covering can extend into the rigid region of the door leaf, thus achieving a uniform appearance of the door leaf overall.

In another embodiment of the invention, the flexible region of the door leaf is provided with a flexible insulating material which is clad by means of a flexible covering panel as a surface covering. Such a covering panel, in addition to giving an improved external appearance, simultaneously makes it possible to improve the design of the door leaf, for example by this panel being connected, e.g. welded, to corner elements, in order to form a stable and possibly closed external structure in particular in the corners. Such a flexible panel may be, for example, a PVC panel with a wall thickness of a few millimeters, for example of 4 mm. However, other plastics are also possible for this purpose.

As has already been mentioned, the flexible region is preferably reinforced by reinforcing elements. A further improvement of the door leaf is achieved here when such reinforcing elements are anchored in the rigid region of the door leaf. This makes it possible to ensure reliable dimensional stability not just in the transition region, but throughout the flexible region.

If the reinforcing elements extend far into the flexible region, which in the extreme case may mean as far as the opposite wall, then this significantly improves the dimensional stability of the flexible region.

Arranging the reinforcing elements obliquely can also prove advantageous in order to counteract the gravitation force acting on the flexible materials of the flexible region. This makes it possible to prevent or reduce for example the “flow” of a plastic or the like, in which case the flexible region can only deform to a slight extent, if at all, in the downward direction.

The flexibility of the door leaf in the flexible region can be set using different measures. Alongside the corresponding selection of materials, it is also possible to provide a layered construction, it being possible, if appropriate, for corresponding layers to be displaced in relation to one another.

In another embodiment of the invention, two layers of such a flexible region can be displaced in relation to one another, in which case the desired flexibility can be achieved even with a corresponding thickness of the door leaf.

Furthermore, the use of flexible materials gives rise to the risk of permanent bowing arising in one direction or the other over the course of time as the door is in operation. In order to counteract this, for example tension elements may be provided in the flexible region, these being fastened in certain regions, for example in the bottom inner corner region and in the rigid region. By virtue of these tension elements being subjected to tension, to a certain extent the flexible region can be made to assume the desired shape. Such tension elements are preferably of adjustable design, in which case it is also subsequently possible for a door leaf according to the invention to be readily realigned in the flexible region.

Another embodiment provides that the flexible region is fastened in a releasable manner on the rigid region of the door leaf. Such a releasable design, for example using belt or strap locks or the like as fastening means, has advantages in the event of damage being caused, since in this case all that is required is for the flexible region to be exchanged. Such a design also has advantages if particular hygiene-related requirements have to be met since, following an appropriate period of operation, the flexible region can be exchanged for a new one.

In another embodiment, a sensor for sensing objects is provided on at least one side of the door leaf. Such a sensor device can be used, when the sensor is triggered, to open the door in order to avoid a collision. In conjunction with a flexible door-leaf region according to the invention, all that is required here is one such sensor arrangement on one side of the door. If a collision takes place from the opposite side, then the flexible door-leaf region can be flexed until it triggers the sensor. Since cold-store facilities usually have very quick-opening doors, then even in the event of a collision from the side located opposite the sensor the door can be opened quickly enough, by sensor triggering, for damage or destruction to be avoided as the vehicle drives up.

An advantageous embodiment of such a sensor consists in using a light curtain which triggers a signal when it is interrupted. This means that the door leaf is monitored over its surface area. With the light curtain of appropriate size, it is thus possible to monitor, for example, the entire door surface.

### BRIEF DESCRIPTION OF THE DRAWINGS

An exemplary embodiment of the invention is illustrated in the drawing and will be explained in more detail hereinbelow with reference to the figures.

FIG. 1 shows a front view of a cold-store sliding door according to the invention in the closed state;

FIG. 2 shows a plan view of a double-leaf door according to FIG. 1;

FIG. 3 shows an enlargement, in detail form, of the floor guide of a door according to FIG. 1;

FIG. 4 shows an enlargement, in detail form, of a cross section through a door according to FIG. 1;

FIG. 5 shows a sectional illustration through a door leaf according to FIG. 6;

FIG. 7 shows a sectional illustration through the flexible region of a door leaf; and

FIG. 8 shows a plan view of a sliding door according to the invention with a sensor device.

### DETAILED DESCRIPTION OF THE INVENTION

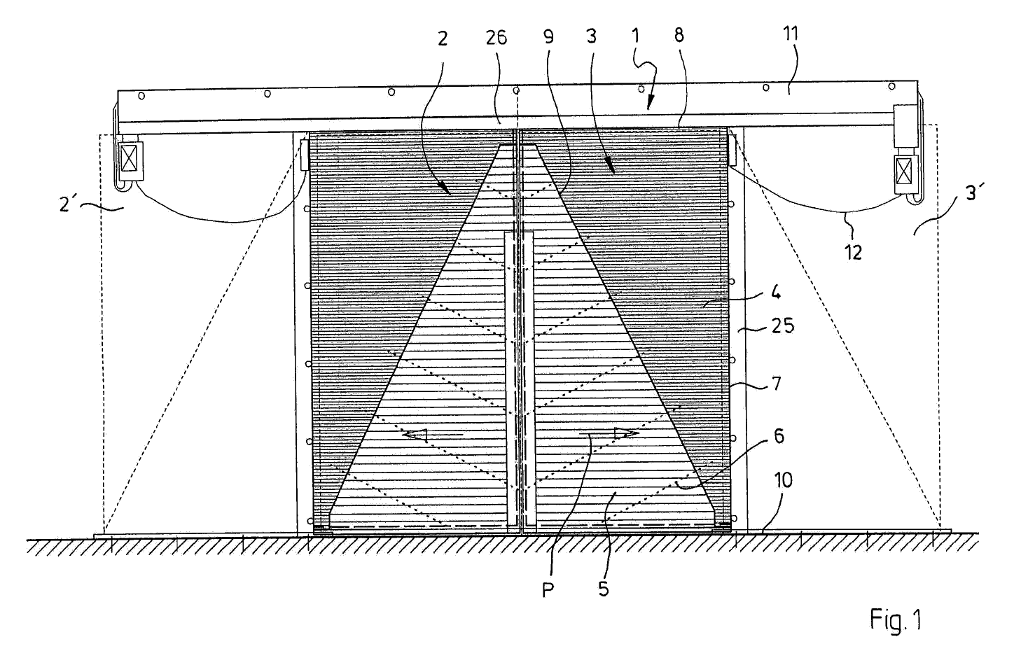

The cold-store sliding door 1 according to FIG. 1 comprises two door leaves 2, 3 which, in the position illustrated, are closed and can be opened in the direction of the arrows P. The open position of the door leaves 2′, 3′ is illustrated by dashed lines. The two door leaves 2, 3 are provided, according to the invention, with a rigid region 4 and a flexible region 5. In the flexible region 5, reinforcing elements 6, for example spring-steel rods, are indicated by dashed lines.

The rigid region 4 extends, on the longitudinal side 7, over the entire height of the door leaf and, on the transverse side 8, over the entire width of the door leaf. The connecting line 9 between the rigid region 4 and the flexible region 5 shows that the width of the flexible region increases from top to bottom in the direction of the floor 10.

A crossmember 11, which comprises drive elements for opening the door, is located on the top side. Also illustrated are trailing cables 12 for the heaters (not shown specifically in FIG. 1).

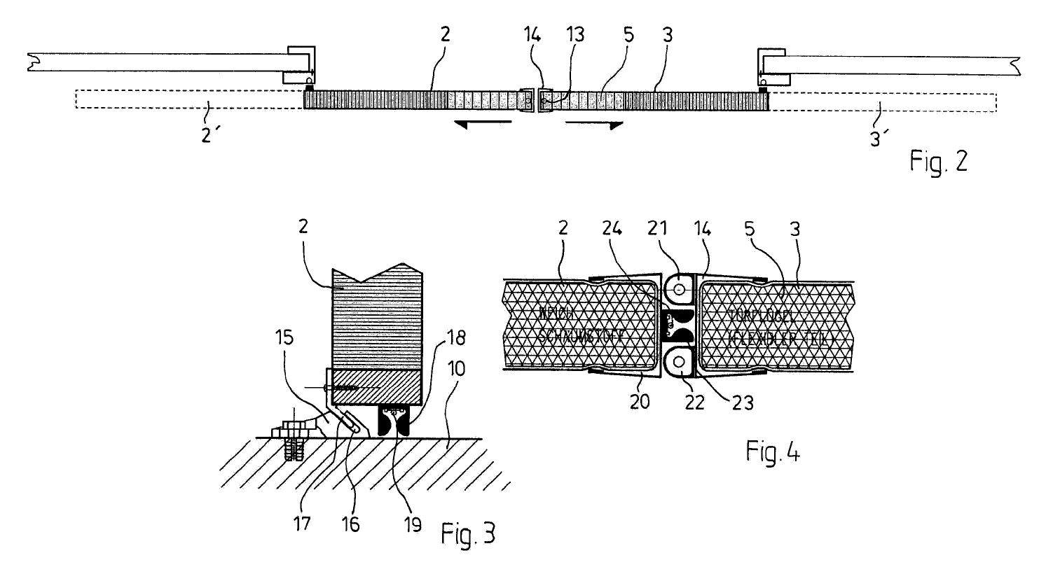

FIG. 2 shows, once again, the door leaves 2, 3 in the closed position and in the open position 2′, 3′. It can be seen here that the narrow side 13 of the flexible region 5 is covered by a U-shaped profile 14.

The floor connection can be seen in FIG. 3. A guide profile 15 is fastened, in this specific case screwed, on the floor 10. This guide profile 15 comprises a guide groove 16 in which engages a guide finger 17 which, for its part, is screwed on the door leaf 2. FIG. 3 also shows a floor-side sealing profile 18 with internal heater 19.

FIG. 4 illustrates the termination between the door leaves 2, 3 in the flexible region 5 on an enlarged scale. The two door leaves 2, 3 are covered by U-shaped profiles 14, 20. On the door leaf 3, safety strips 21, 22 are connected to the U-shaped profile 14 and, in the present embodiment these strips are deformable and are provided with a sensor system (not illustrated specifically) for sensing such deformations. Such a sensor system can communicate the deformation to the control means of the door drive, in which case the closing operation is interrupted and, if desired in such cases, the door is opened again. Any desired safety routines may be provided for here in the region of the drive control means.

In the exemplary embodiment illustrated, the safety strips are configured such that they engage around a sealing profile 23 fastened on the U-shaped profile 20 of the door leaf 2. The sealing profile 23 also encloses a heater 24. In conjunction with the sealing profile 23, the safety strips 21, 22 give rise to an additional labyrinth seal in the region of the closing location between the door leaves 2, 3. They also protect the seal 23.

The rigid region 4 of each door leaf 2, 3 ensures good attachment to the door frame 25, 26 on the top transverse side 8 and on the longitudinal side 7. The displaceable bearing means (not illustrated specifically) of the individual door leaves 2, 3 can be fastened in rigid and solid fashion on the top transverse side 8. This therefore results in reliable guidance in the displacement direction. This is improved further on the floor side by the guide elements, e.g. in the form of the guide finger 17 and in the guide profile 15, likewise being fitted on the rigid region 4.

The flexible regions 5 of the door leaves 2, 3 in contrast, reduce the risk of damage when a vehicle, for example a stacker truck, drives through quickly when the door is not yet sufficiently open. The reinforcing elements 6, for example in the form of spring steel, cause the door leaves 2, 3 to yield in the flexible region 5 and also ensure that they are reliably restored into the starting position as soon as the application of force ceases.

The additional features such as coverings, seals and heaters ensure further protective and sealing functions and reliably prevent such a cold-store sliding door from freezing.

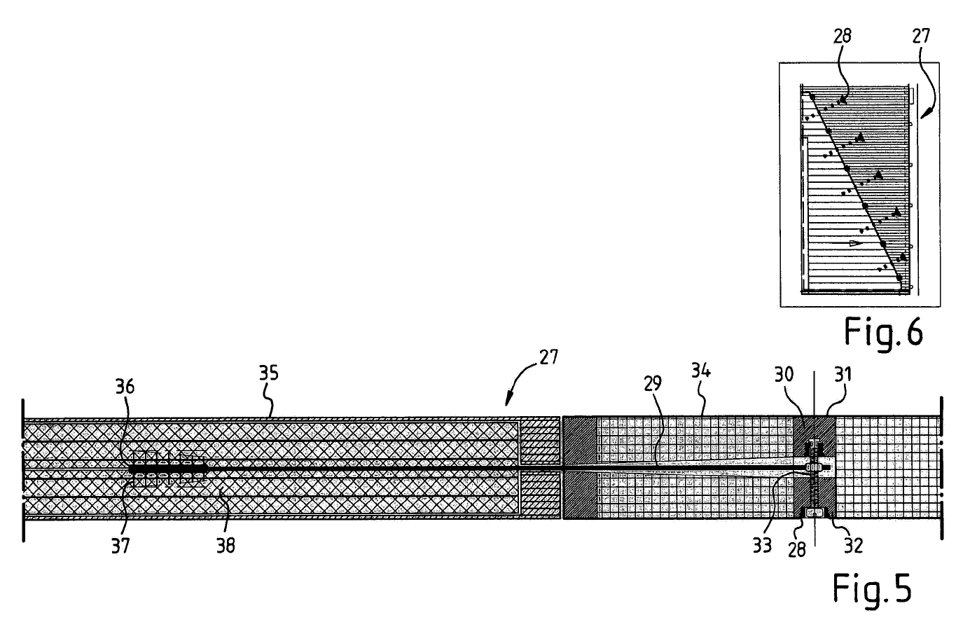

The door leaf 27 according to FIGS. 5 and 6 corresponds essentially to the door leaves 2, 3 described above. The illustration according to FIG. 6, and in particular that according to FIG. 5, shows the fastening elements 28 of reinforcing elements made of spring band steel 29. An anchor block 30 contains a recess 31 into which the spring band steel 29 projects. It is fixed on a bolt 33 there such that it can be adjusted by a nut 32. The fastening device 28 is firmly anchored in the rigid door-leaf region 34.

The spring band steel 29 projects into the flexible door-leaf region 35, where it is anchored in the flexible insulating material 38 at the end using an anchor element 36, via transverse anchor rods. The further the spring band steel 29 projects into the flexible door-leaf region 35, the more capable it is of performing load-bearing functions there, provided it is anchored in the rigid door-leaf region 34 at the opposite end. By rotating the bolt 33, it is possible to vary the position of the nut 32, and thus the one end of the spring band steel 29, in relation to the plane of the door leaf. This makes it possible to adjust the alignment of the flexible door-leaf region 35 in relation to the door plane. If, for example, the flexible door-leaf region 35 is deformed on a permanent basis as a result of vehicles repeatedly driving up to and against it, then this adjustment option makes it possible to adjust the shape of the flexible entry region 35 accordingly.

In the embodiment according to FIGS. 5 and 6, the flexible door-leaf region 35 can additionally be released from the rigid door-leaf region by the bolt 33 being released. It is thus easy to exchange the flexible door-leaf region.

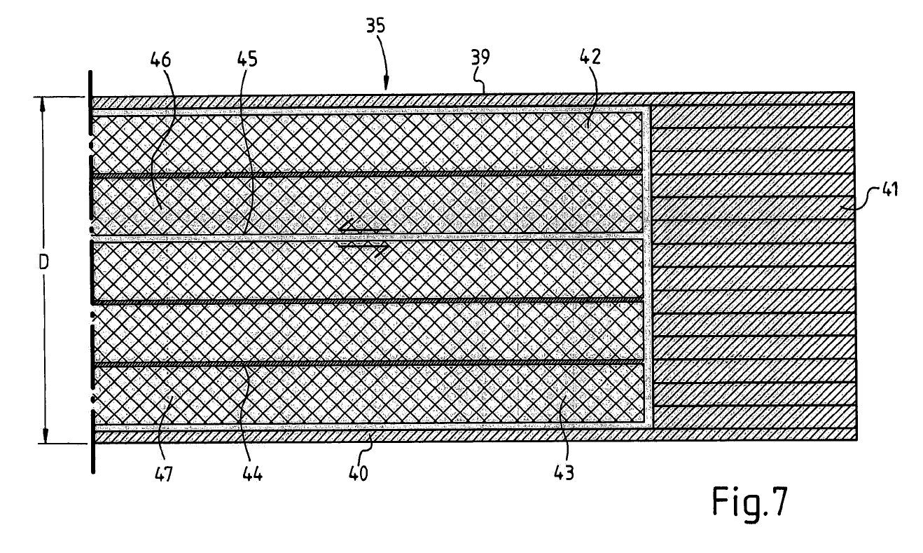

FIG. 7 shows a variant for the internal construction of a flexible door-leaf region 35 between two outer wall panels 39, 40 which are connected, for example adhesively bonded, on the end side to a termination block 41. The termination block 41, in this embodiment, is configured with multiple layers as a laminate.

The insulating material 42 is constructed in a plurality of layers formed from insulating mats 43. Most of these insulating mats 43 here are connected to one another via an adhesive-bonding layer 44. This results, in turn, in a laminate made of insulating mats 43.

In order not to impair the flexibility of the flexible door-leaf region 35 too far on account of the thickness D of this door-leaf region 35, advantageous embodiments can provide for such insulating mats 43 to be displaceable. In the present case, for example the boundary surface 45 between the top layer 46, which is formed from two adhesively bonded insulating mats 43, and the bottom layer 47, which in the present case is formed from three such adhesively bonded insulating panels 43, is not adhesively bonded. The top layer 46 and the bottom layer 47 can thus be moved in relation to one another, as a result of which the flexibility of the flexible door-leaf region 35 increases in relation to a version with full adhesive bonding.

This option of increasing or decreasing the flexibility of a layered structure depending on how many layers are connected, for example, adhesively bonded, to one another, or on how many layers are arranged for displacement in relation to one another, can be utilized in order to adjust the flexibility as desired. It is possible here to use different materials and different thicknesses D for the door leaf, two or more layers which can be displaced in relation to one another giving rise to an increase in the flexibility and layers which are connected, or adhesively bonded, to one another throughout causing the door leaf to be reinforced.

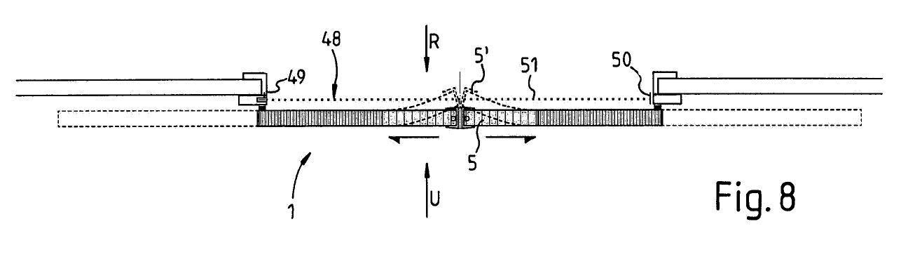

FIG. 8 shows a door arrangement according to FIG. 2, this time with a sensor device 48 being provided. The sensor device 48 here contains a transmitter 49 and a receiver 50, which form a light curtain 51. When a vehicle approaches the door from the rear side in the direction of the arrow R, for example when it drives up against the same, the light curtain 51 is immediately broken, in which case the door is opened via a corresponding control means. When a vehicle approaches the front side of the cold-store sliding door 1 in the direction U, flexible regions 5, in the first instance, are pushed in, which is indicated by 5′. The flexible regions 5 thus pass into the region of action of the light curtain 51, in which case the sensor device 48 triggers opening of the door. The flexible regions 5 according to the invention thus make it possible, in addition, to control the opening operation of the cold-store sliding door 1 automatically with just one sensor device on just one side of the door.

The door-leaf configuration described is not just advantageous for sliding doors as in the exemplary embodiments; it can also be used in other doors, e.g. swing doors or up-and-over doors. Furthermore, the invention covers not just double-leaf doors, but also single-leaf or multi-leaf doors.

List of Designations

| | |
|---|---|
| 1 | Cold-store sliding |
| | door |
| 2 | Door leaf |
| 3 | Door leaf |
| 4 | Rigid region |
| 5 | Flexible region |
| 6 | Reinforcing element |
| 7 | Longitudinal side |
| 8 | Transverse side |
| 9 | Connecting line |
| 10 | Floor |
| 11 | Crossmember |
| 12 | Trailing cable |
| 13 | Narrow side |
| 14 | U-shaped profile |
| 15 | Guide profile |
| 16 | Guide groove |
| 17 | Guide finger |
| 18 | Sealing profile |
| 19 | Heater |
| 20 | U-shaped profile |
| 21 | Safety strip |
| 22 | Safety strip |
| 23 | Sealing profile |
| 24 | Heater |
| 25 | Door frame |
| 26 | Door frame |
| 27 | Door leaf |
| 28 | Fastening device |
| 29 | Spring band steel |
| 30 | Anchor block |
| 31 | Recess |
| 32 | Nut |
| 33 | Bolt |
| 34 | Rigid door-leaf region |
| 35 | Flexible door-leaf region |
| 36 | Anchor element |
| 37 | Anchor rods |
| 38 | Insulating material |
| 39 | Wall panel |
| 40 | Wall panel |
| 41 | Terminating block |
| 42 | Insulating material |
| 43 | Insulating mats |
| 44 | Adhesive-bonding layer |
| 45 | Boundary surface |
| 46 | Top layer |
| 47 | Bottom layer |
| 48 | Sensor device |
| 49 | Transmitter |
| 50 | Receiver |
| 51 | Light curtain |

We claim:

1. A thermally insulating door having at least one door leaf which, in the installed state, is mounted such that it can be displaced in front of a cold-store opening, wherein the door leaf has at least one rigid region and at least one flexible region.

2. The door as claimed in claim 1, comprising two door leaves.

3. The door as claimed in claim 1, further comprising bearing means for bearing the door in a displaceable manner, said bearing means being arranged on the rigid region of the door leaf.

4. The door as claimed in claim 1, wherein the rigid region, on a top side of the door leaf, extends over the entire width of the door leaf.

5. The door as claimed in claim 1, wherein the flexible region is located on a drive-through side of the door leaf, which, in the open state, is oriented toward an envisaged drive-through opening.

6. The door as claimed in claim 5, wherein the width of the flexible region increases from the drive-through side in the direction of the floor.

7. The door as claimed in claim 1, further comprising a covering on a drive-through side of the flexible region.

8. The door as claimed in claim 7, wherein the covering of the flexible region has a rigid profile.

9. The door as claimed in claim 1, further comprising a heater around at least part of the periphery of the door leaf.

10. The door as claimed in claim 1, further comprising a seal around at least part of the periphery of the door leaf.

11. The door as claimed in claim 1, further comprising a safety element for safeguarding objects located in the closing region of the door.

12. The door as claimed in claim 1, wherein the rigid region of the door leaf extends down to the floor.

13. The door as claimed in claim 1, wherein the rigid region of the door leaf comprises a floor-guide element.

14. The door as claimed in claim 1, wherein at least one of the flexible region and the rigid region of the door leaf comprises an insulating material.

15. The door as claimed in claim 1, wherein the flexible region has a flexible insulating material which is covered by one or more flexible covering panels.

16. The door as claimed in claim 1, wherein the flexible region of the door leaf comprises reinforcing elements.

17. The door as claimed in claim 16, wherein the reinforcing elements are anchored in the rigid region of the door leaf.

18. The door as claimed in claim 16, wherein the reinforcing elements consist, at least in part, of stainless steel.

19. The door as claimed in claim 1, wherein the door leaf, in the flexible region, has at least two layers which are displaceable in relation to one another.

20. The door as claimed in claim 1, further comprising at least one tension element in the flexible region in order to counteract permanent bowing of the door leaf.

21. The door as claimed in claim 1, wherein the flexible region is fastened in a releasable manner on the rigid region of the door leaf.

22. The door as claimed in claim 1, further comprising a sensor device for sensing objects, said sensor device being provided on at least one side of the door leaf.

23. The door as claimed in claim 22, wherein the sensor device comprises a light curtain.

24. The door as claimed in claim 1, wherein it is designed as a single-leaf or multi-leaf sliding door and/or swing door and/or up-and-over door.
